(19) United States
(12) Patent Application Publication
(10) Pub. No.: US 2013/0301376 A1
(43) Pub. Date: Nov. 14, 2013

(54) PORTIONING AND KNEADING DRUM

(71) Applicants: Robert Sauseng, St. Radegund (AT); Zlatko Bajrektarevic, Graz (AT)

(72) Inventors: Robert Sauseng, St. Radegund (AT); Zlatko Bajrektarevic, Graz (AT)

(73) Assignee: Konig Maschinen Gesellschaft M.B.H., Graz (AT)

(21) Appl. No.: 13/636,116

(22) PCT Filed: Apr. 13, 2011
(86) PCT No.: PCT/EP2011/055759

§ 371 Date: Sep. 27, 2012

(30) Foreign Application Priority Data
Apr. 16, 2010 (AT) A 627/2010

(51) Int. Cl. A21C 1/14

(52) U.S. Cl. CPC A21C 1/1465
USPC 366/100

(57) ABSTRACT

A device for portioning and kneading dough is provided, comprising a chamber drum incrementally rotatable about a drive shaft by a main drive provided at the circumferential sections thereof with accommodation chambers, wherein in each accommodation chamber there may be slid one or a plurality of weighing stamps in the radial direction of the chamber drum by motion-according coupling with a control device. At least one circumferential section of the chamber drum, which has at least one accommodation chamber, may be removed and re-attached in the axial direction together with the weighing stamp situated in the accommodation chamber. Each weighing chamber is motion-accordingly coupled with the control device by a lever shaft, which is provided at one of its lever shaft ends with a cam roller housed in a cam-like curved compulsory guiding of a control device.

The invention relates to a device for portioning and kneading dough, having a chamber drum incrementally rotatable about a drive shaft by way of a main drive, which is provided at the circumferential sections thereof with accommodation chambers for the dough portions to be kneaded, wherein in each accommodation chamber there may be slid one or a plurality of weighing stamps in the radial direction of the chamber drum by means of motion-according coupling with a control device.

Known from prior art are numerous embodiments of devices for portioning and kneading dough. For example, from the document EP 0 643 914 B1 there is known a measuring chamber dough dividing machine having a measuring chamber support, wherein there is arranged a number of filling chambers provided with filling pistons. The measuring chamber dough dividing machine essentially consists of at least one filling chamber having one filling piston that may be moved axially back and forth. Onto the housing of the filling chamber or the filling piston, respectively, there is arranged a dough funnel. At the front-side opening of the filling chamber there is arranged a rotatably pivotable measuring chamber support having an internally positioned measuring piston, which forms a measuring chamber with a varying measuring volume. Underneath the measuring chamber support, there is situated a kneading drum having a kneading band as well as subsequent expansion bands for discharging the dough portions.

The operating principle of the weighing unit having a pivotable measuring chamber support that is shown in EP 0 643 914 B1 has already been known from the document DE 3530724 C1.

Before the dough is changed and before every longer shut-down of the measuring chamber dough dividing machine, the measuring chamber and the measuring piston as well as the filling chamber and the filling piston, respectively, have to be cleaned or also replaced, if required. Therefore, the weighing unit of the measuring chamber dough dividing machine has to be brought into its cleaning position. For a faster positioning into the respective cleaning position, the measuring chamber dough dividing machine known from EP 0 643 914 B1 is provided with a switch, which stops the dough dividing machine in its disassembly position for the measuring piston or the filling piston.

This embodiment is disadvantageous insofar as in other dough dividing weighs, which do not lie within the hub displacement area of the measuring pistons, the entire weighing unit including the pivotable measuring chamber support has to be replaced by another unit having respectively bigger or smaller measuring chambers.

The document DE 100 09 300 C2 describes a method and a device for producing circular dough pieces of the same size. Therein, dough gets out of the storage funnel into a main chamber situated underneath and is introduced therefrom into dough chambers, which are arranged at a kneading drum in a radially fillable way, by way of a horizontally movable main piston. Inside the dough chambers there are provided dough chamber pistons that may be adjusted at the front face. The free volume of the dough chambers may be adjusted within a certain limit by the dough chamber pistons and, hence, the portion size of the individual dough portions may be influenced. A kneading band for closing the dough chambers is only required along a short circumferential section of the kneading drum.

Further there is known from document WO 01/76374 A1 a device for portioning and kneading dough offering a solution to the task that the kneading pressure applied at the kneading site onto the piece of dough may be altered independently of the turning of the compulsory guiding and that it is possible to adapt the kneading pressure to the different dough volumes or dough qualities, respectively. For this purpose, there is provided in the inside of a kneading drum a cam roller that causes in the individual dough chambers a compulsory guiding of the piston connected with a frame.

Furthermore, there is known from the document DE 10 2006 018 626 A1 a portioning unit, wherein there may be removed for cleaning purposes respectively linear cylindrical strips in the radial direction of a dough drum. This device is only intended for portioning dough. With the portioning unit it is not possible to knead the dough portions.

In these embodiments it is disadvantageous that in the dough dividing weights, which do not lie within the hub displacement area of the dough chamber pistons or measuring pistons, respectively, the entire weighing unit or the entire kneading drum unit, respectively, has to be replaced by another unit having respectively bigger or smaller measuring chambers. Due to the rather complex adjustment mechanics, a complete replacement of a kneading drum unit or a weighing unit, respectively, is especially time-consuming and costly and may only be performed by properly trained maintenance personnel. It is a further disadvantage that in these embodiments, in particular if there are to be processed different doughs of varying portion size rather frequently with a dough dividing and kneading device, each replacement of the kneading drum unit or the weighing unit, respectively, will result in a longer shut-down of the operation.

The present invention thus has the task to prevent the disadvantages already known from prior art for portioning and kneading devices for dough of the initially stated type. This task is solved in a processing device according to the preamble of the claim 1 by way of the features of the characterizing part of the claim 1. The sub-claims relate to especially advantageous embodiments of the invention.

In a device according to the invention for portioning and kneading dough, having a chamber drum incrementally rotatable about a drive shaft by way of a main drive, which is provided at the circumferential sections thereof with accommodation chambers for the dough portions to be kneaded, wherein in each accommodation chamber there may be slid one or a plurality of weighing stamps in the radial direction of the chamber drum by means of motion-according coupling with a control device, at least one circumferential section of the chamber drum, which has at least one accommodation chamber, is especially advantageously configured to be removable and re-attachable in the axial direction together with the weighing stamp situated in the accommodation chamber.

The replacement operation for the chamber drum in a device according to the invention may thus especially advantageously be carried out safely and efficiently by simple action. An especially trained operation personnel, hence, is not required for replacing the chamber drum.

In a device according to the invention at least one circumferential section of the chamber drum is usefully configured as a replaceable replacement insert having replacement insert guiding, which may be form-fittingly inserted into and extracted out of the chamber drum guidings of the chamber drum.

Such replacement inserts have the advantage that for different dough weights or different sizes and forms of dough portions, respectively, the proper replacement inserts may be exchanged extraordinarily easily as well as quickly. Due to the form-fitting guidings at the replacement inserts, which may be attached in complementarily fitting guidings at the chamber drum to be inserted and extracted, in this embodiment of a device according to the invention the set-up time is advantageously significantly reduced. The profitability of the device as well as the achievable through-put of dough portions will be remarkably increased due to the shortened operational shut-downs during the modification thereof.

The adjustable weight area of the dough portion sizes, which has so far been limited in the dough dividing systems known from prior art due to the geometry of an adjustable rotary slide or a measuring piston, will be significantly increased in a device according to the invention, presenting another advantage of the invention.

A device having a replacement insert with a single big accommodation chamber may be intended for dividing and kneading dough portions for big loaves of bread. Further replacement inserts may, for example, have several smaller accommodation chambers, which are arranged respectively in rows next to each other at a circumferential section of the replacement insert or the chamber drum, respectively. In this way, there may also be portioned dough portions of different sizes for small-sized bakery products by the same device in two rows—with two accommodation chambers arranged next to each other—or in a plurality of rows—with, for example, three or more accommodation chambers arranged next to each other.

In an embodiment variant according to the invention, the entire chamber drum may be removed and re-attached in the axial direction together with all weighing stamps situated in the accommodation chambers.

This embodiment variant is insofar comfortable as the chamber drum with all weighing stamps is configured to be quickly replaceable. In this way, the set-up or shut-down time of the running operation is further reduced, and chamber drums of different forms having accommodation chambers arranged next to each other in one or several rows may be adjusted to the dough portion size respectively required, according to the product to be produced, very quickly by means of replacement.

According to the embodiment variant of the chamber drum, the adjustment mechanism may remain locally fixed at the frame of the device in order to move the weighing stamp in the accommodation chambers. Essentially, only the chamber drum including the weighing stamps is replaced. Alternatively, also the adjustment mechanism for the movement of the weighing stamps, e.g., also the lever shafts including the control device, may be configured as a unit that is arranged within the chamber drum and that may be replaced together with the chamber drum.

Advantageously, in a device according to the invention each weighing stamp is motion-accordingly coupled with the control device by way of a lever shaft that is provided at its lever shaft end with a cam roller for the form-fitting accommodation in a cam-like curved compulsory guiding of a control device.

The lever shafts are moved towards each other by way of the compulsory guiding of the control device and guarantee a correct displacement of the weighing stamps within the respective accommodation chambers in correspondence with the currently prevailing position at the rotatable chamber drum. According to the position of the circulating chamber drum, the chamber depth of the accommodation chambers intended for accommodating the dough, which is respectively defined by the internal walls of the accommodation chambers and the external front face of the movable weighing stamp, is determined by the respective position of the lever shafts.

In a variant of a device according to the invention at least two weighing stamps, which are respectively provided in accommodation chambers of a circumferential section of the chamber drum that are arranged in rows next to each other, are especially usefully motion coupled with the control device by way of a common lever shaft.

In particular in two or a plurality of accommodation chambers respectively arranged in rows next to each, which are provided at a circumferential section of a replaceable chamber drum or at an exchangeable replacement section, it is advantageous that these accommodation chambers are each moved synchronously by a common lever shaft.

In a device according to the invention each weighing stamp is usefully protected by way of mechanical stops and/or magnetic holders against dropping out of the accommodation chamber.

Such weighing stamps that are protected against dropping out provide for especially convenient handling during the set-up thereof. The weighing stamps of a replacement insert or a chamber drum, hence, remain in their position within the accommodation chambers in position, which further provides for advantages in regard to handling and storage in the case of non-utilization. Chamber drums of different shapes thus may be stored as replaceable units directly at the device, without the weighing stamps being accidentally mixed up or lost. For cleaning purposes, the weighing stamps may simply be manually removed from the accommodation chambers and after cleaning be re-introduced into the accommodation chambers.

In a device according to the invention, each weighing stamp advantageously contacts the lever shaft at its lever shaft neck at least in a position of the accommodation chamber in which it is filled with dough.

This embodiment, in comparison with embodiments known from prior art, wherein the weighing stamp is connected with the lever shaft by means of rods or by way of a mounting, has the advantage, among others, that herein the weighing stamp in a position of the accommodation chamber, in which it is filled with dough, is situated only contacting the lever shaft. In principle, the lever shaft thus serves as a pulse generator for the weighing stamp and pushes it within the accommodation chamber in the radial direction towards the outside. Due to the dough filled into the accommodation chamber, the weighing stamp is then pushed against the lever shaft contacting it. Due to the mechanic coupling of the weighing stamp with the lever shaft that is lacking herein, for example by means of rods, the chamber drum together with the weighing stamps situated in the accommodation chambers may especially conveniently be pulled off in the axial direction from the device or of the lever shafts, respectively, which are, e.g., attached to the frame of the device.

In a device according to the invention, the rotatably positioned chamber drum may be releasably attached at a connection flange.

The connection flange in turn is connected with a main drive, e.g., by means of a gearbox. Herein, there may be used all known quick release fasteners for a quickly releasable attachment of the chamber drum at the connection flange, which are all comprised by the invention. In this way a quick removal of the chamber drum from the drive or from the device, respectively, is possible.

In a device according to the invention, the connection flange as well as the control device is coupled with a drive by way of a gearbox.

The control device, which has a cam-like curved track as a compulsory guiding for the form-fitting accommodation of the lever shaft ends, as well as the connection flange for the releasable attachment of the chamber drum are provided, by means of a gearbox, with a drive, which is preferably decoupled from the main drive. The control device as well as the connection flange may be moved towards each other at, for example, a relative velocity, by means of a gearbox.

In a device according to the invention, there is especially advantageously provided at least a locking device for securing the chamber drum and/or the replacement inserts in the assembled position.

A locking device may, for example, comprise a locking ring, which is attached at its front face at the chamber drum or at a respectively suitable position at the frame of the device and which locks the position of the rotatable chamber drum and/or the replacement inserts in the assembled position. The most varied embodiments of a locking device are conceivable.

In a device according to the invention, there is usefully provided at least one monitoring device for monitoring the assembled position of the chamber drum and/or the replacement inserts.

By means of a monitoring device, there is prevented that the device, upon replacement of chamber drum or replacement inserts, be operated even if the chamber drum or the replacement inserts are not positioned in the assembled position. In a chamber drum having replaceable replacement inserts there is, for example, prevented that, in the case of lacking replacement inserts, dough enters the adjustment mechanism of the weighing stamps in the inside of the chamber drum and that this will lead to the device being damaged.

In a development of the device, the monitoring device comprises at least a position detecting sensor, preferably an optical and/or capacitive and/or piezo-electrical and/or inductive position detecting sensor.

This at least one position detecting sensor is, for example, attached at the housing of the device and detects the position of the chamber drum and/or of the replacement inserts in the assembled position. If the position detecting sensor detects an error in the assembled position of the construction parts to be monitored, there will be, e.g., transmitted an error signal to a control device, and the device cannot be put in operation.

In a device according to the invention, the chamber drum and/or the replacement inserts are advantageously made of a suitable plastic or of a material coated with plastic, which is preferably dough-repellent.

In a device according to the invention the chamber drum and/or the replacement inserts are especially usefully made of a material containing aluminium.

The chamber drum and/or the replacement inserts are, for example, made of aluminium extrusion profiles. Also the use of materials consisting of aluminium alloys for the production of the chamber drum and/or of the replacement inserts is comprised by the invention.

In an embodiment variant according to the invention there may be attached a support bearing at the free drive shaft end for bearing the drive shaft.

In particular in chamber drums with a big construction length, which, e.g., carry multiple-row accommodation chambers, a second bearing, for example a rolling bearing, for bearing the drive shaft, is especially advantageous.

Summarizing, the device according to the invention further has the advantage that most varied embodiment variants of chamber drums according to the invention, which may be provided with or without replaceable replacement inserts, may be very quickly and efficiently re-adapted. The geometric arrangement of the accommodation chambers or the weighing stamps situated therein, respectively, at the circumference of the replaceable chamber drum or at the replaceable replacement inserts, respectively, is not limited at all. The accommodation chambers may be arranged in one, two or several rows next to each other or row-like in the axial direction at the circumference of the chamber drum.

Also the distance in the circumferential direction between the individual accommodation chambers that are arranged, e.g., row-like next to each other in the axial direction may be varied according to the requirements. The invention comprises, for example, circular segments between two adjoining rows arranged in one or several rows of accommodation chambers, which are offset from each other by half of the circumference, by a third of the circumference, a fourth or also a fifth, a sixth etc. of the circumference. In principle, the rows of accommodation chambers are arranged evenly distributed in an integer number of circular segments over the circumference of the chamber drum. Chamber drums may, for example, have only two, three or four accommodation chambers, which are arranged in a single row in even circular segments alongside the circumference of the chamber drum. The chamber drums each may also have several accommodation chambers for portioning small-sized bakery products, which chambers are arranged in multiple rows next to each other, wherein the rows are arranged spaced apart from each other, for example, in the circumferential direction respectively in a sixth of the circumference.

The accommodation chambers further may have different cross-sectional geometries. There may also be conceived, for example, circular or oval as well as polygonal cross-sectional geometries of the accommodation chambers. The weighing stamps are each formed in a way so that these are movable within the accommodation chambers in the longitudinal direction thereof as well as that these are flush with the internal walls of the accommodation chambers. In this way, there is prevented that dough enters through a gap between the weighing stamps and the accommodation chambers into the internal space of the chamber drum situated behind.

Further features of the invention are obvious from the following description of exemplary embodiments and in reference to the schematic drawings,

wherein:

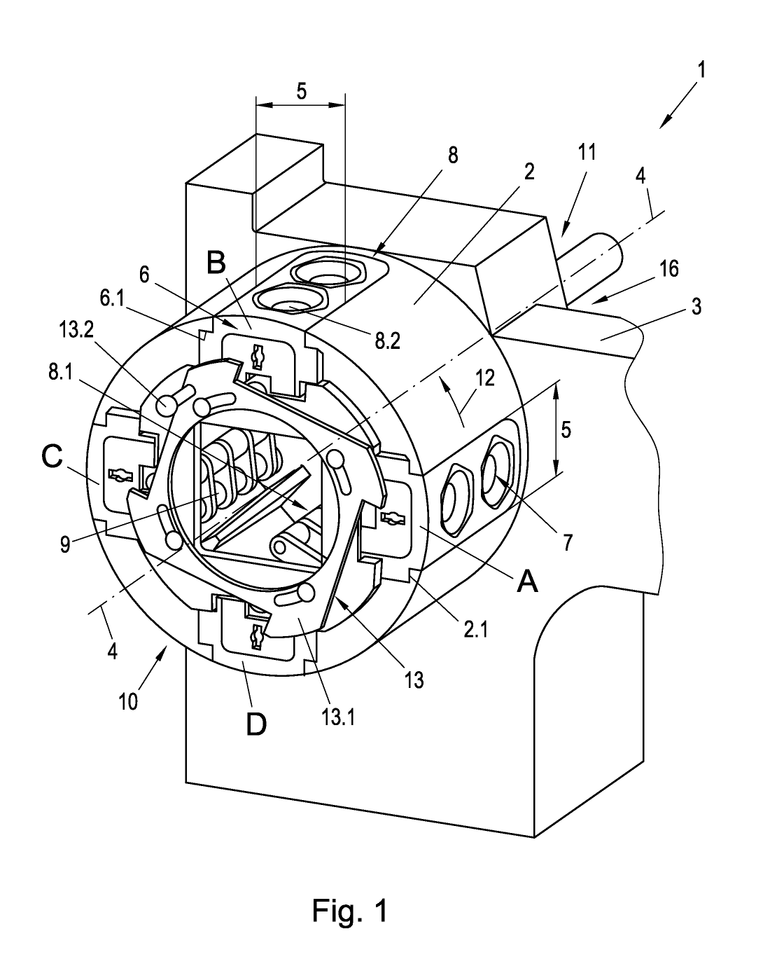

FIG. 1 shows a first embodiment variant of a chamber drum of a device according to the invention in a detailed depiction in an inclined front elevation;

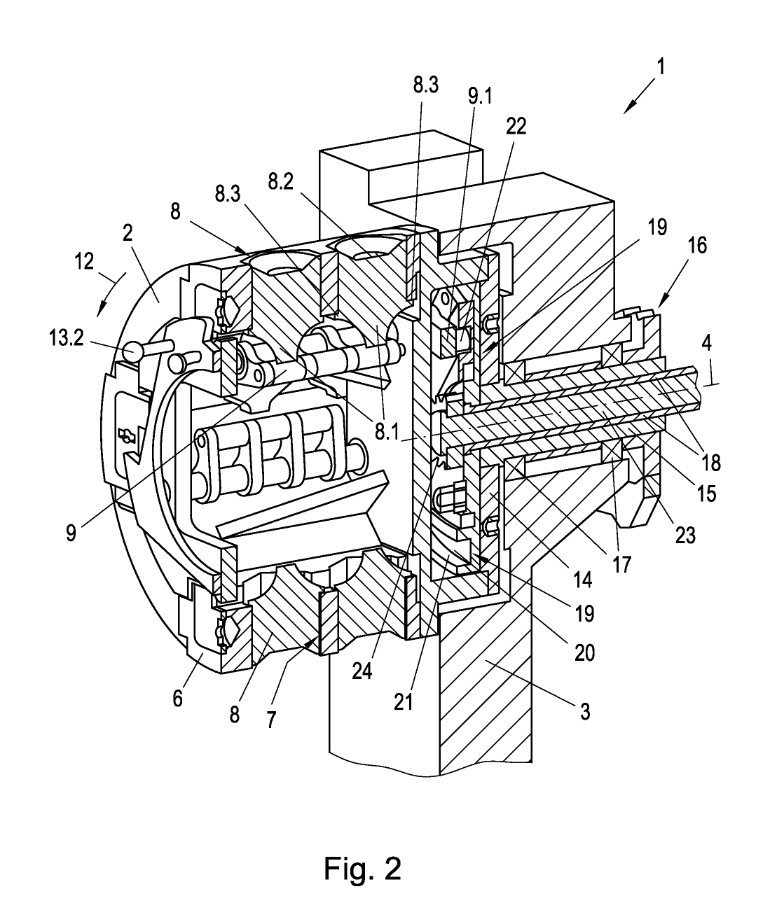

FIG. 2 shows the embodiment variant shown in FIG. 1 in an inclined sectional side view;

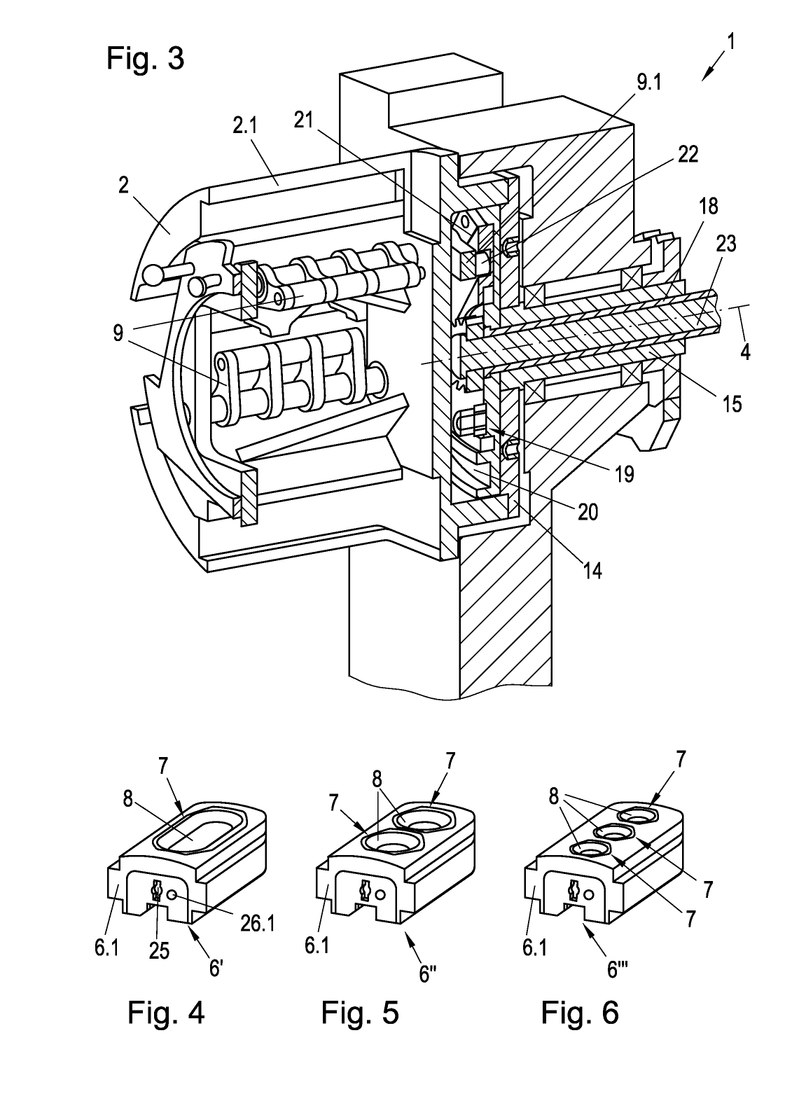

FIG. 3 shows the embodiment variant shown in FIG. 2 with pulled-off replacement inserts in an inclined sectional side view;

FIG. 4, FIG. 5 and FIG. 6 show different embodiment variants of exchangeable replacement inserts, each suitable to be inserted into the chamber drum shown in the FIGS. 1 to 3;

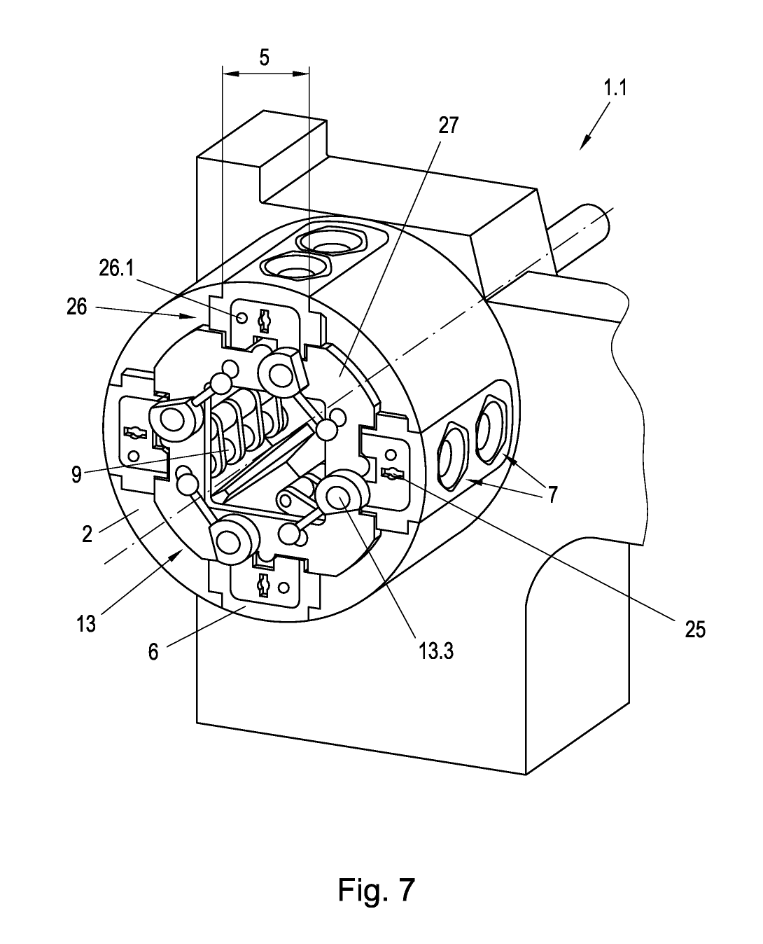

FIG. 7 shows a variant of the chamber drum shown in FIG. 1 in a detailed front elevation;

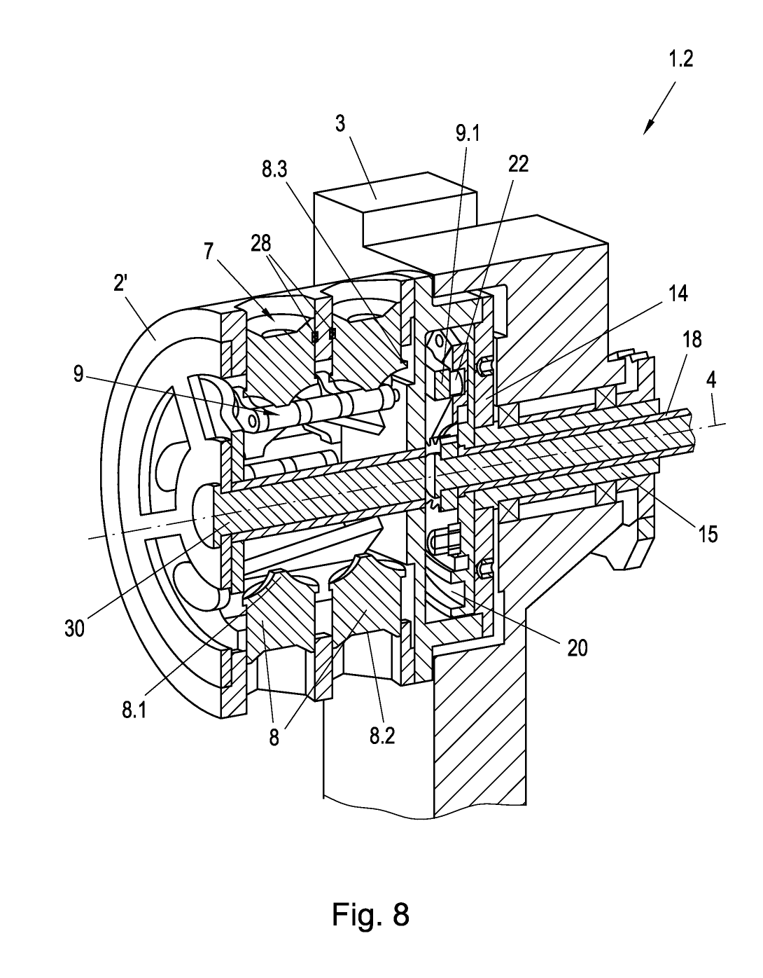

FIG. 8 shows another embodiment variant of a device according to the invention in an inclined sectional side view;

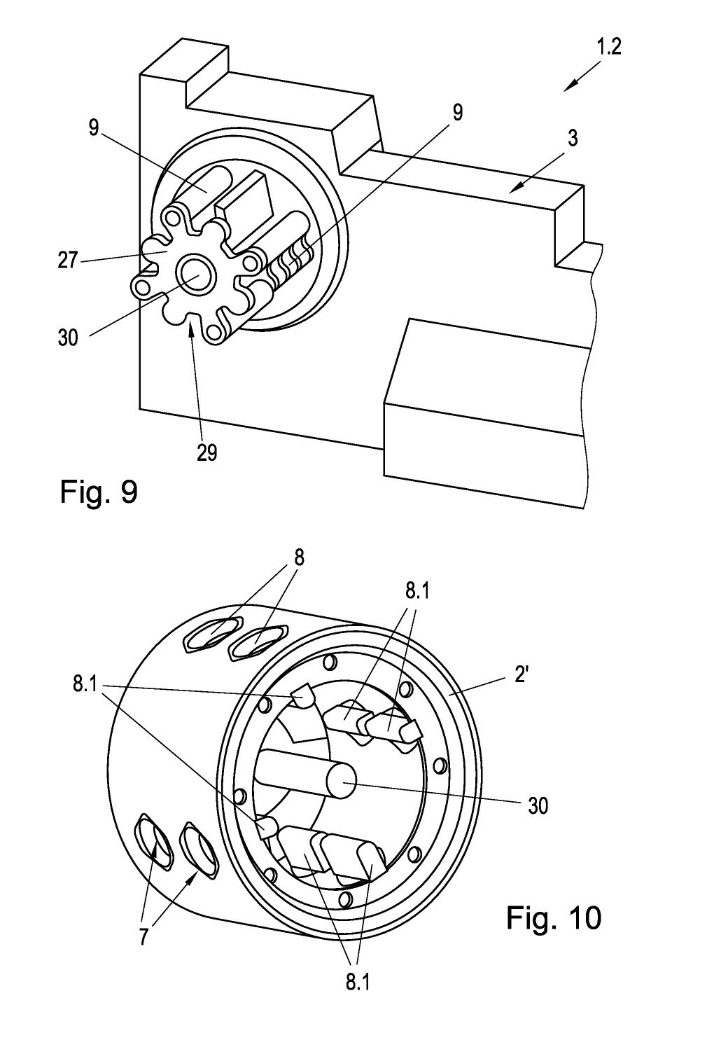

FIG. 9 shows the device depicted in FIG. 8 with pulled-off chamber drum in an inclined detailed front elevation;

FIG. 10 shows in detail the chamber drum shown in FIG. 8;

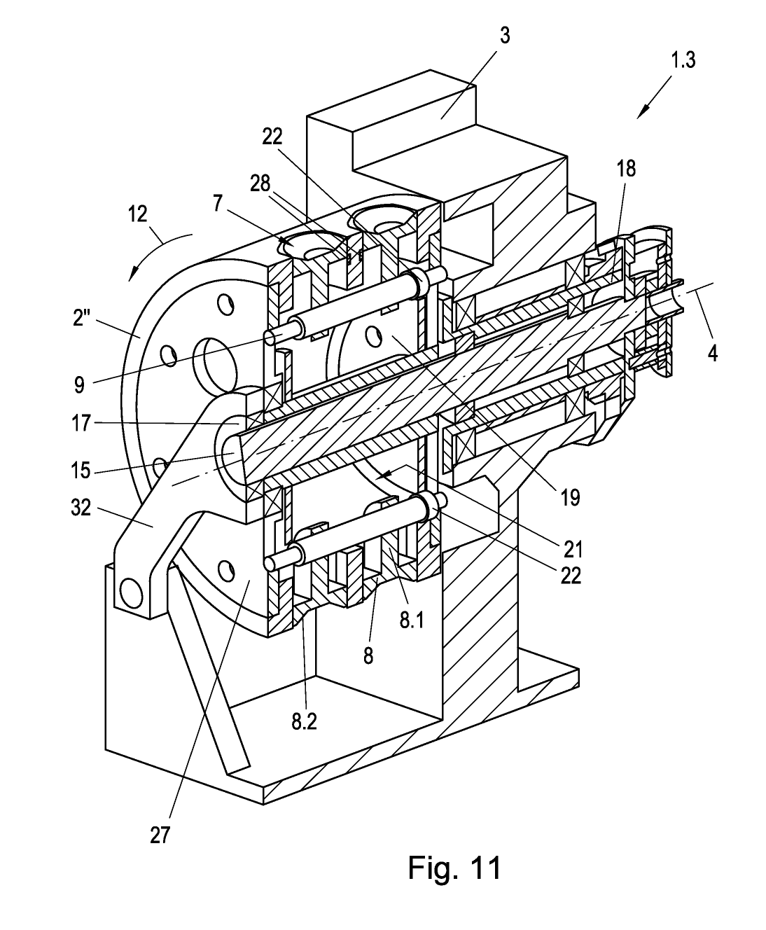

FIG. 11 shows another embodiment variant of a device according to the invention in a sectional side view;

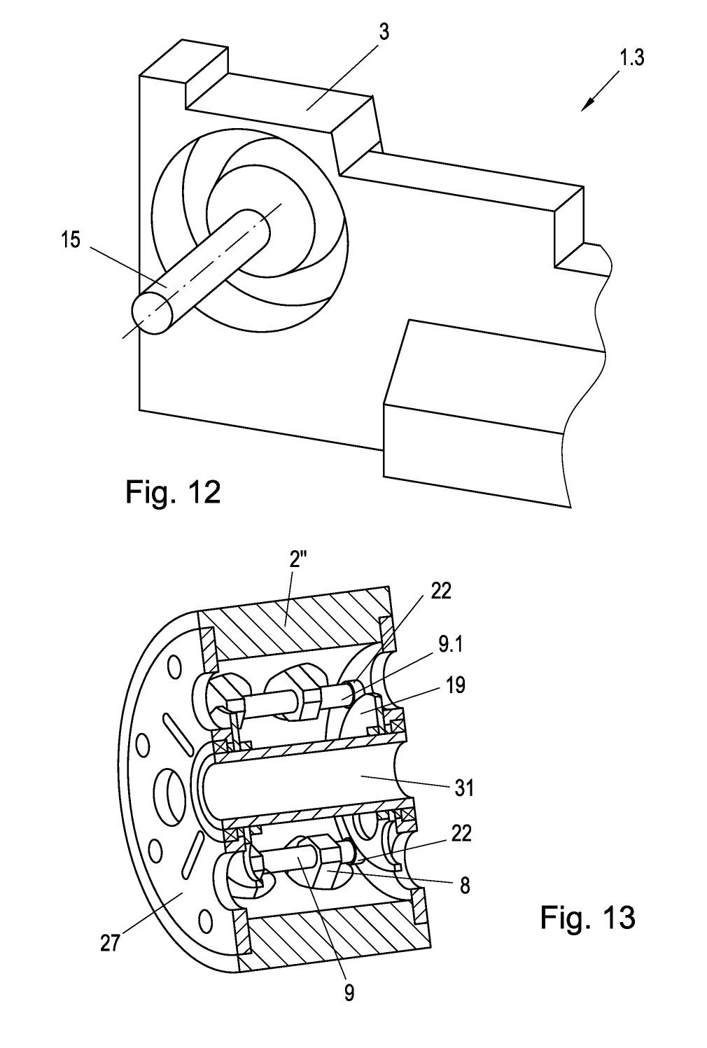

FIG. 12 shows the device shown in FIG. 11 with pulled-off chamber drum in a detailed front elevation;

FIG. 13 shows in a detailed depiction the chamber drum shown in FIG. 11.

FIG. 1 shows in an inclined view a device 1 according to the invention with a detailed depiction of a chamber drum 2. The device 1 has a frame 3, at which the chamber drum 2 is rotatable about an axis 4. The chamber drum 2 has at its circumference at several circumferential sections 5, which are provided being replaceable as replacement inserts 6 in the axial direction, respectively two accommodation chambers 7 that are, for example, arranged in rows next to each other. The accommodation chambers 7 or the replacement inserts 6, respectively, are evenly distributed over the circumference of the chamber drum 2. In each of the accommodation chambers 7 there are situated movable weighing stamps 8, which are controlled by several lever shafts 9 arranged in the inside of the chamber drum 2 in regard to their position within the accommodation chamber 7.

For a better overall view, the covers or construction parts, respectively, of a housing 10 of the device 1 are not depicted. The chamber drum 2 is further rotated by a main drive 11 incrementally in always the same direction 12. In this way, a dough to be processed is in this way moved from the outside, for example through a dough feed device not shown, e.g., by a dough feed piston, to the accommodation chambers 7 of the rotatable chamber drum 2, which are designated with position A. The movable weighing stamps 8 are pushed into position A, which is designated as dough filling position, by the dough that is fed thereto, in the radial direction in the accommodation chambers 7, until the weighing stamps 8 each abut at a lever shaft 9 with their internal stamp neck or their front face 8.1., respectively. The dough volume, which is accommodated in position A respectively in a hollow space formed by the accommodation chamber 7 as well as the external front face 8.2. of the weighing stamp 8 pushed towards the inside, may be adjusted by the respectively adjusted position of the lever shaft 9, which forms an adjustable stopper for the internal front face 8.1. of the weighing stamp 8.

The dough pressed into the accommodation chambers 7 is sheared off, e.g., by a shearing edge not depicted herein, when the chamber drum 2 moves further in the direction of rotation 12. In this way, the actual portioning of the dough pieces is realized. The two dough pieces situated in the accommodation chambers 7, upon rotation of the chamber drum 2 of 90°, are moved into the designated position B, which is also designated as kneading position. Thereby, the dough pieces situated in the accommodation chambers 7 are kneaded, for example, from the outside by a kneading device not shown through a circulating movement of a kneading tool of the kneading device. In position B, for example in the course of a kneading process, there is performed further impressing of the weighing stamp 8 within the accommodation chambers 7, by the lever shaft 9 being adjusted correspondingly during the kneading process. The hollow space within the accommodation chamber 7 that is limited and thus enlarged by the weighing stamp 8 advantageously offers more space to the dough piece being kneaded.

The chamber drum 2 is again further rotated about 90° in the direction of rotation 12 after the kneading process, and the replacement insert 6 provided with the two accommodation chambers 7 is moved into the dough discharge position designated as position C. The lever shaft 9 is thus adjusted in a way so that the weighing stamps 8 are pushed towards the outside in the radial direction and that the external front faces of the two weighing stamps 8 are each flush with the circumferential area of the chamber drum 2. The portioned and kneaded dough pieces are transferred in position C, by the weighing stamps 8 that are pushed out of the accommodation chambers 7, e.g., onto a conveyer belt not depicted.

In position D the two accommodation chambers 7 are without any dough filling. Due to gravity, in this position the weighing stamps 8 are situated in the accommodation chambers 7 in a position pushed radially towards the outside or downside, respectively. The weighing stamps 8 are provided with a mechanical stop 8.3 in order to prevent dropping out of the respective accommodation chamber 7. This mechanical stop 8.3 is shown in detail in FIG. 2 and is situated in the proximity of the internal front face 8.1 of the weighing stamps 8. Further, the weighing stamps 8 may be protected against dropping out of the respective accommodation chamber 7 by way of, e.g., a magnetic holder.

The position D, hence, serves especially as a replacement position for pushing the exchangeable replacement inserts 6 in and out. The replacement inserts 6 are provided at the two opposite longitudinal sides thereof with replacement insert guidings 6.1, which may be inserted form-fittingly into the chamber drum guidings 2.1 of the chamber drum 2. In order to replace the replacement inserts 6, there has to be locked correspondingly a locking device 13, which comprises a locking ring 13.1 that is attached at the front face of the chamber drum 2. Therefore, there is, for example, opened a detent pin 13.2 before displacement, which protects the locking ring 13.1 in operation against displacement, and the locking ring 13.1 is rotated within a guiding formed by slotted hole slits, so that the slides of the replacement inserts 6 each may be pulled out of the corresponding chamber drum guidings 2.1. in position D of the chamber drum 2.

The replacement inserts 6 shown herein, which each have two accommodation chambers 7, may rather easily be exchanged for, e.g., further replacement inserts 6 each having a big accommodation chamber 7 or alternatively for such inserts each having three or more smaller accommodation chambers 7. For cleaning purposes, the weighing stamps 8 may be removed from the accommodation chambers 7 of the pulled-off replacement inserts 6.

The herein shown embodiment with replacement inserts 6, which each have two accommodation chambers 7 and which are arranged each offset in four segments of the circumference of the chamber drum 2, this is offset by 90°, is merely one possible exemplary embodiment. The replacement inserts 6, for example, may also have more than two accommodation chambers 7, or replacement inserts 6 may, for example, be arranged in six or eight segments of the circumference of the chamber drum 2, this is each offset by 60° or 45°, respectively, at a chamber drum. These embodiments, however, are not explicitly shown in the figures.

FIG. 2 shows the chamber drum 2 known from FIG. 1 of a device 1 according to the invention in an inclined sectional side view.

The chamber drum 2 is attached at a connection flange 14, which is connected with a drive shaft 15 that is formed as a hollow shaft by way of a gear 16 with the main drive 11. The drive shaft 15 may be rotated directly at the frame 3 by means of rolling bearings 17. Within the drive shaft 15 embodied as a hollow shaft there is provided a further hollow shaft 18, which penetrates the drive shaft 15 and is born therein. At the free end of the hollow shaft 18 there is attached a control device 19, which is formed by a disc having a compulsory guiding 20 for the lever shafts 9. The compulsory guiding 20 comprises a curved track 21, wherein the lever shafts 9 form-fittingly circulate, each having a lever shaft end 9.1, which is provided with a cam-roller 22. The lever shafts 9 are motion-coupled with the control device 19. A shaft 23 penetrating the hollow shaft 18 as well as the drive shaft 15 is provided at the front end thereof with a gear 24. By means of the gear 24, the course of the cam-like curved track 21, which is provided for the compulsory guiding 20 of the lever shafts 9, may be adjusted on a segment-like embodied control device 19 that may be adjusted in multiple parts. At this point, there will not be discussed any further advantages and details known per se of a curved track 21 of a compulsory guiding 20 of the lever shafts 9, which curved track may be adjusted while being in operation.

FIG. 3 shows the embodiment variant depicted in FIG. 2 of a device 1 with pulled-off replacement inserts 6 in an inclined sectional side view. Herein, the chamber drum guidings 2.1 at the chamber drum 2, which are intended for the form-fitting accommodation of the slide-like formed replacement inserts 6, are especially clearly visible.

The illustrations FIG. 4, FIG. 5 and FIG. 6 each represent different embodiment variants of exchangeable replacement inserts 6, which are respectively suitable for insertion into the free circumferential sections 5 of the chamber drum 2 shown in the FIGS. 1 to 3.

In FIG. 4 there is shown a first variant of a replacement insert 6′, which has a single big accommodation chamber 7 with the weighing stamp 8 situated therein. The accommodation chamber 7 herein is embodied, e.g., having an oval cross-section. Respectively at the two narrow longitudinal sides of the replacement insert 6′ there are provided replacement insert guidings 6.1 for the precise and form-fitting accommodation in the correspondingly complementarily formed chamber drum guidings 2.1, which are visible, e.g., in FIG. 3. At the front face, anterior in the assembled position, of the replacement insert 6′ there is provided approximately centrally at the front face an opening 25 for inserting a pull-off tool. By means of a pull-off tool, which is introduced in the opening 25, the replacement insert 6′ may be pushed out or pulled off, respectively, of the chamber drum 2 especially conveniently.

Furthermore, there is characterized a monitoring screw 26.1. A monitoring device 26 indicated in FIG. 7, which comprises at least one position detecting sensor, determines by way of the position and the presence of the monitoring screw 26.1 at the replacement inserts 6, whether the replacement inserts 6 are correctly positioned in the chamber drum 2 in the assembled state.

The at least one position detecting sensor, which is not explicitly represented herein, is attached, e.g., at the internal door side of a housing cover not depicted herein of the device. Upon replacement of the chamber drum or of the replacement inserts, the device may then be put into operation again, for example, only if the housing cover is properly closed and if the monitoring device 26 detects the correct assembled position of the chamber drum 2 and/or of the replacement inserts 6.

FIG. 5 shows a further embodiment variant of a replacement insert 6″ having two accommodation chambers 7 arranged in rows next to each other or the weighing stamps 8 situated therein, respectively. The accommodation chambers 7 herein have, for example, a hexagonal cross-section.

FIG. 6 shows a third embodiment variant of a replacement insert 6′″, which has the same external dimensions as the replacement inserts shown in FIG. 4 as well as FIG. 5 and which is provided with three accommodation chambers 7 that are arranged in rows next to each other as well as with the weighing stamps 8 situated therein. The accommodation chambers 7 herein have, for example, also a hexagonal cross-section.

FIG. 7 shows a variant of the chamber drum shown in FIG. 1 in a detailed front elevation. The device 1.1 shown herein has a chamber drum 2, which is comprehensively provided with a locking device 13 comprising several retaining levers 13.3. The retaining levers 13.3 therefore are arranged at the front-face bearing plate 27 of the chamber drum 2 and provide for an especially comfortable as well as easy locking or unlocking, respectively, when the replacement inserts 6 are replaced. A monitoring device 26, which detects the correct assembled position of the chamber drum 2 and/or of the replacement inserts 6, for example by way of the position as well as the existence of monitoring screws 26.1, is herein only indicated.

The illustrations FIG. 8 to FIG. 10 refer to another variant of a device 1.2 according to the invention.

FIG. 8 shows the device 1.2 in an inclined sectional side view. The device 1.2 has a rotatable chamber drum 2′, which is releasably attached at the connection flange 14 in the direction of the axis 4. The adjustment mechanism of the weighing stamps 8 including the lever shafts 9 as well as the cam rollers 22 herein remains connected with the frame 3 of the device 1.2 and is not exchanged when the chamber drum 2′ is replaced. Magnetic holders 28 in the area of the accommodation chambers 7 provide for a high level of convenience when the chamber drum 2′ is set up. Through the magnetic holders 28, there is prevented that the weighing stamps 8 drop out of the accommodation chambers 7 while the chamber drums 2′ are being replaced.

In FIG. 9 there is visible the device 1.2 shown in FIG. 8 with pulled-off chamber drum 2′ in an inclined detailed front elevation. In order to simplify the re-attachment of the chamber drum 2′, there are provided at the anterior bearing plate 27 feed openings 29 for accommodating the stamp necks 8.1 of the weighing stamps 8. A guiding pin 30 of the chamber drum 2′ is for this reason pushed in the direction of the axis 4 into a central recess or guiding sleeve 31, respectively, centrally of the bearing plate 27.

FIG. 10 shows in detail the chamber drum 2′ shown in FIG. 8 in the state wherein it is pulled off the device 1.2. The weighing stamps 8 then each remain in the accommodation chambers 7 and are replaced together with the chamber drum 2′. In the inside of the chamber drum 2′ there are visible the stamp necks 8.1 of the weighing stamps 8.

The illustrations FIG. 11 to FIG. 13 refer to a further embodiment variant of a device 1.3 according to the invention.

FIG. 11 shows the device 1.3 in a sectional side view. The chamber drum 2″ may in this embodiment be completely removed from the frame 3 of the device 1.3 together with the adjustment mechanism arranged in the inside thereof for adjusting the weighing stamps 8, comprising the lever shafts 9, the cam rollers 22 provided at the lever shaft ends 9.1 as well as the control device 19. For replacement reasons, the chamber drum 2″ is for this reason pulled off from the drive shaft 15 in the direction of the axis 4 or it is conversely slid onto the drive shaft 14, respectively. The drive of the chamber drum 2″ may be realized by means of the drive shaft 15, which is non-rotatably connected with the chamber drum 2″. The chamber drum 2″ is then positioned with a central guiding sleeve 31 on the drive shaft 15. Alternatively, the chamber drum 2″ may also be attached at the connection flange 14, and driving the chamber drum 2″ is, for example, performed through a connection flange 14 connected with a hollow shaft 18.

At the free end of the drive shaft 15 there is situated a support bearing 32, which carries, for example, a rolling bearing 17 for accommodating the drive shaft 15 and which serves as a second or third, respectively, bearing of the drive shaft 15. This embodiment offers, in particular in regard to chamber drums 2″ having a great construction length with several accommodation chambers 7 arranged in multiple rows, the advantage that the bearing of the chamber drum 2″ is realized at its two front faces. The weight distribution of the chamber drum 2″ is thus significantly improved. For replacement of the chamber drum 2″, the support bearing 32 is simply swivelled to the side or removed from the drive shaft 15, respectively.

FIG. 12 shows the device 1.3 shown in FIG. 11 with pulled-off chamber drum 2″ in a detailed front elevation.

FIG. 13 represents in a detailed depiction in a sectional view the chamber drum 2′ in FIG. 11 in the pulled-off position. The adjustment mechanism arranged in the inside of the chamber drum 2″ is herein replaced completely together with the chamber drum 2″.

### LIST OF POSITION NUMBERS

| | |
|---|---|
| 1 | device (or 1.1; 1.2; 1.3, resp.) |
| 2 | chamber drum (or 2′, 2″, resp.) |
| 2.1 | chamber drum guiding |
| 3 | frame |
| 4 | axis |
| 5 | circumferential section |
| 6 | replacement insert (or 6′, 6″, 6″′, resp.) |
| 6.1 | replacement insert guiding |
| 7 | accommodation chamber |
| 8 | weighing stamp |
| 8.1 | stamp neck (internal front face) |
| 8.2 | external front face |
| 8.3 | stop angle |
| 9 | lever shaft |
| 9.1 | lever shaft end |
| 10 | housing |
| 11 | drive |
| 12 | direction of rotation |
| 13 | locking device |
| 13.1 | locking ring |
| 13.2 | detent pin for locking ring |
| 13.3 | retaining lever |
| 14 | connection flange |
| 15 | drive shaft |
| 16 | gearbox |
| 17 | rolling bearing |
| 18 | hollow shaft |
| 19 | control device |
| 20 | compulsory guiding |
| 21 | cam-like curved track |
| 22 | cam roller |
| 23 | penetrating shaft |
| 24 | gear |
| 25 | opening for pull-off-tool |
| 26 | monitoring device |
| 26.1 | monitoring screw |
| 27 | bearing plate |
| 28 | magnetic holder |
| 29 | feed opening |
| 30 | guiding pin |
| 31 | guiding sleeve |
| 32 | support bearing |
| A | dough filling position |
| B | kneading position |
| C | dough discharging position |
| D | replacement position |

1. A device for portioning and kneading dough, comprising: a chamber drum incrementally rotatable about a drive shaft by way of a main drive,
wherein the main drive is provided at circumferential sections of the chamber drum with accommodation chambers for dough portions to be kneaded,
wherein each accommodation chamber is configured such that one or a plurality of weighing stamps can be slid, by motion-according coupling with a control device, into the accommodation chamber in a radial direction of the chamber drum,
wherein at least one circumferential section of the chamber drum comprises at least one accommodation chamber, and is configured to be removed and re-attached in an axial direction together with the weighing stamp situated in the at least one accommodation chamber, and
wherein each weighing stamp is motion-accordingly coupled with the control device by a lever shaft, wherein the control device is provided at one of lever shaft ends with a cam roller, and wherein the cam roller is housed in a cam-like curved compulsory guiding of a the control device.

2. The device according to claim 1, comprising at least two weighing stamps, each of which is provided in a respective accommodation chamber, wherein each weighing stamp is motion-accordingly coupled with the control device by a common lever shaft, wherein the accommodation chambers associated with the at least two weighing stamps are arranged in rows next to each other at the circumferential section of the chamber drum.

3. The device according to claim 1, wherein at least one circumferential section of the chamber drum comprises a replaceable replacement insert comprising replacement insert guidings, wherein the replaceable replacement insert is configured to form-fittingly be inserted into and extracted out of chamber drum guidings of the chamber drum.

4. The device according to claim 1, wherein an entire chamber drum is configured to be removed and re-attached in an axial direction together with all weighing stamps situated in the accommodation chambers.

5. The device according to claim 1, further comprising at least one of mechanical stops or magnetic holders configured to protect each weighing stamp from dropping out of the accommodation chamber.

6. The device according to claim 1, wherein each weighing stamp contacts the lever shaft through a stamp neck at least in a dough-filled position of the accommodation chamber.

7. The device according to claim 1, wherein the chamber drum is configured to be releasably attached at a connection flange.

8. The device according to claim 7, wherein the connection flange as well as the control device are coupled with the main drive by a gearbox.

9. The device according to claim 3, further comprising at least one locking device for securing at least one of the chamber drum or the replacement inserts in an assembled position.

10. The device according to claim 9, further comprising at least one monitoring device for monitoring the assembled position of at least one of the chamber drum or the replacement inserts.

11. The device according to claim 10, wherein the monitoring device comprises at least one position detecting sensor.

12. The device according to claim 3, wherein at least one of the chamber drum or the replacement inserts comprise plastic or a material coated with plastic.

13. The device according to claim 1, further comprising a bearing support at a free end of a drive shaft end to bear the drive shaft.

14. The device according to claim 11, wherein the at least one position detecting sensor is selected from the group consisting of an optical detecting sensor, a capacitive detecting sensor, a piezo-electrical detecting sensor and an inductive position detecting sensor.

15. The device according to claim 12, wherein the plastic is dough-repellent.
